(19) United States
(12) Patent Application Publication
(10) Pub. No.: US 2021/0125254 A1
(43) Pub. Date: Apr. 29, 2021

(54) SYSTEM FOR RECOMMENDING SUBSCRIPTIONS AND SERVICES

(71) Applicant: PAYPAL, INC., San Jose, CA (US)

(72) Inventors: Megan O'Neill, San Jose, CA (US); Gregory Crescimanno, San Jose, CA (US); Dereck Quock, Santa Clara, CA (US); Haidan Huang, San Francisco, CA (US); Maanasa Priyaa Dharmapuri Sridhar, Bangalore (IN); Shilpa Dhar, Los Altos, CA (US); Zhuangdi Li, San Jose, CA (US); Agnal Kokkat, San Jose, CA (US)

(21) Appl. No.: 16/665,431

(22) Filed: Oct. 28, 2019

(51) Int. Cl. G06Q 30/06; G06Q 30/04; G06Q 30/02

(52) U.S. Cl. CPC G06Q 30/0631; G06Q 30/0201; G06Q 30/0282; G06Q 30/04

(57) ABSTRACT

A computer system identifies user information corresponding to a user. The computer system analyzes the user information to identify a service associated with the user. The computer system determines one or more other users that correspond to the identified service associated with the user. The computer system determines one or more services to recommend to the user based on identifying a plurality of services associated with the determined one or more other users, wherein the plurality of services correspond to a plurality of service providers. The computer system provides one or more billing agreements to the user via a user interface, wherein the one or more billing agreements correspond to the determined one or more services.

### TECHNICAL FIELD

The present disclosure relates to recommendations, and more particularly to a system and method for recommending subscriptions and services.

### BACKGROUND

The payments landscape has changed drastically over the past decade. This is primarily due to fintech and e-commerce companies that have allowed consumers to have simple and frictionless shopping experiences online, while also allowing consumers to easily pay for bills or re-occurring subscriptions. However, the identification and sign-up process of services, such as subscription services, can in some cases take a fair amount of time. Oftentimes this can lead to customer frustration and a lower conversion rate for companies and merchants that offer these services. There is a need for innovation that can ease the friction that customers feel with regard to identifying and signing up for subscription services.

### BRIEF DESCRIPTION OF THE DRAWINGS

FIG. 1 illustrates a recommendation system, in accordance with an embodiment.

FIG. 2 is a flowchart illustrating the operations of the recommendation application of FIG. 1 in determining one or more service recommendations to provide a user, in accordance with an embodiment.

FIG. 3 is a flowchart illustrating the operations of the recommendation application of FIG. 1 in determining whether a billing agreement corresponds to cancellation criteria, in accordance with an embodiment.

FIG. 4 is a depiction of a user interface that provides the ability for a user to manage one or more services/subscriptions, in accordance with an embodiment.

FIG. 5 is a depiction of a user interface that provides a user with a categorical view of one or more services/subscriptions, in accordance with an embodiment.

FIG. 6 is a depiction of a user interface that provides a user with one or more recommended services and/or subscriptions, in accordance with an embodiment.

FIG. 7 is a depiction of a user interface that provides a user with a payment feed of one or more connected users, in accordance with an embodiment.

FIG. 8 is a block diagram depicting the hardware components of the recommendation system of FIG. 1, in accordance with an embodiment.

### DETAILED DESCRIPTION

Embodiments of the present disclosure provide a system, method, and program product. A computer system identifies user information corresponding to a user. The computer system analyzes the user information to identify a service associated with the user. The computer system determines one or more other users that correspond to the identified service associated with the user. The computer system determines one or more services to recommend to the user based on identifying a plurality of services associated with the determined one or more other users, wherein the plurality of services correspond to a plurality of service providers. The computer system provides one or more billing agreements to the user via a user interface, wherein the one or more billing agreements correspond to the determined one or more services.

In another embodiment, a computer system determines that a service associated with a user corresponds to one or more cancellation criteria associated with the service. In response to the determining that the service associated with the user corresponds to one or more cancellation criteria associated with the service, the computer system provides the user with a cancellation notification, wherein the cancellation notification includes a selectable user interface element. In response to detecting that the selectable user interface element has been accessed, the computer system automatically initiates communication with a second service provider associated with the service to cause cancellation of the service.

In the example embodiment, the present disclosure describes a solution that describes determining one or more service and/or subscription recommendations to provide a user by utilizing a recommendation model, in accordance with an embodiment. In the example embodiment, the solution includes identifying user information, which may include currently subscribed user subscriptions or services that may have one or more associated billing agreements and may further include additional user information such as user preferences and user characteristics. Furthermore, the solution includes inputting the user information into a recommendation model in order to determine one or more service and/or subscription recommendations. The solution also includes providing the determined one or more service and/or subscription recommendations to the user.

In the example embodiment, the present disclosure also describes a solution that describes determining whether one or more current services and/or subscriptions correspond to cancellation criteria, in accordance with an embodiment. In the example embodiment, the solution includes identifying one or more billing agreements associated with a user, and further determining if the one or more billing agreements correspond to cancellation criteria. Based on determining that the one or more billing agreements do correspond to cancellation criteria, the present solution includes providing a notification to the user that includes a cancellation option. Based on detecting input that corresponds to a selection of the cancellation option, the present solution includes the step of cancelling the billing agreement.

Embodiments of the present disclosure will now be described in detail with reference to the accompanying Figures.

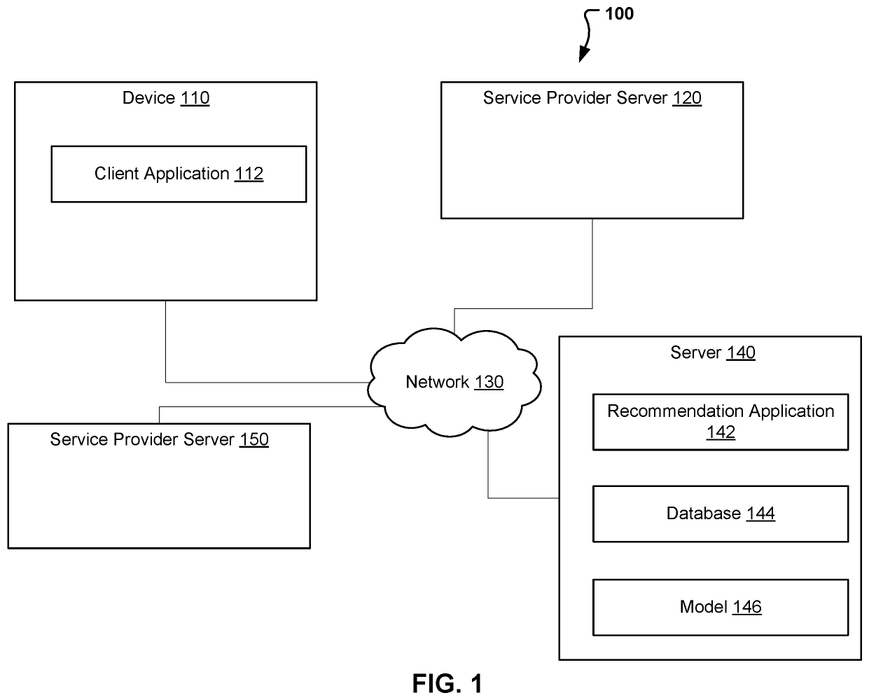

FIG. 1 illustrates recommendation system 100, in accordance with an embodiment.

In the example embodiment, recommendation system 100 includes device 110, service provider server 120, server 140, and service provider server 150 interconnected via network 130.

In the example embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a Bluetooth network, a local area network (LAN), or a wide area network (WAN). In general, network 130 can be any combination of connections and protocols that will support communications between computing devices, such as between device 110 and server 140.

In the example embodiment, service provider server 120 is a server of a merchant or a service provider. For example, service provider server 120 may correspond to an online streaming service provider, an e-commerce service provider, or another type of service provider (or merchant). In the example embodiment, service provider server 120 may be a desktop computer, a laptop computer, a tablet computer, a mobile device, a handheld device, a thin client, or any other electronic device or computing system capable of receiving and sending data to and from other computing devices, such as server 140, via network 130. Although not shown, optionally, service provider server 120 can comprise a cluster of servers executing the same software to collectively process requests as distributed by a front-end server and a load balancer. Service provider server 120 is described in more detail with regard to the figures.

In the example embodiment, service provider server 150 is a server of a merchant or a service provider. For example, service provider server 150 may correspond to an online streaming service provider, an e-commerce service provider, or another type of service provider (or merchant). In the example embodiment, service provider server 150 may be a desktop computer, a laptop computer, a tablet computer, a mobile device, a handheld device, a thin client, or any other electronic device or computing system capable of receiving and sending data to and from other computing devices, such as server 140, via network 130. Although not shown, optionally, service provider server 150 can comprise a cluster of servers executing the same software to collectively process requests as distributed by a front-end server and a load balancer. Service provider server 150 is described in more detail with regard to the figures.

In the example embodiment, device 110 includes client application 112. In the example embodiment, device 110 may be a desktop computer, a laptop computer, a tablet computer, a mobile device, a handheld device, a thin client, or any other electronic device or computing system capable of receiving and sending data to and from other computing devices, such as server 140, via network 130. Device 110 is described in more detail with regard to the figures.

In the example embodiment, client application 112 is a client-side application, corresponding to the server-side recommendation application 142, that is capable of transmitting requests to recommendation application 142 and is further capable of providing received information to a user of device 110 via a user interface. Client application 112 is described in more detail with regard to the figures.

In the example embodiment, server 140 includes recommendation application 142, database 144, and model 146. In the example embodiment, server 140 may be a desktop computer, a laptop computer, a tablet computer, a mobile device, a handheld device, a thin client, or any other electronic device or computing system capable of receiving and sending data to and from other computing devices, such as device 110, via network 130. Although not shown, optionally, server 140 can comprise a cluster of servers executing the same software to collectively process requests as distributed by a front-end server and a load balancer. In the example embodiment, server 140 is a computing device that is optimized for the support of applications that reside on server 140, such as recommendation application 142, and for the support of network requests related to recommendation application 142. Server 140 is described in more detail with regard to the figures.

In the example embodiment, database 144 is a database that includes information that corresponds to one or more users of the service provider associated with server 140, such as one or more user preferences, user transactional history, billing agreements associated with the one or more users (and corresponding subscriptions/services associated with the one or more users), users transaction habits, user financial information, user authentication information, user preferences, user connections (other users that a user may be linked to, connected with, etc.), and additional user information. Database 144 is described in more detail with regard to the figures.

In the example embodiment, model 146 is a model that is capable of receiving an input of user information (and additional information) and providing an output of a subscription and/or service recommendation. In the example embodiment, model 146 may utilize an item based collaborative filtering algorithm in determining an output recommendation, however, in other embodiments, other algorithms such as a context based algorithm, matrix factorization, a user based collaborative filtering algorithm, or an another similar algorithm (or a combination of algorithms) may be utilized by model 146 in determining an output recommendation. Model 146 is described in further detail with regard to the figures.

In the example embodiment, recommendation application 142 is a server-side application, corresponding to the client-side applications such as client application 112. In the example embodiment, recommendation application 142 is capable of receiving information from client applications and further capable of responding to requests from corresponding client applications. In addition, in the example embodiment, recommendation application 142 is capable of identifying relevant user information associated with a request and further utilizing model 146 to identify a recommendation of a subscription or service to provide a user. In addition, recommendation application 142 may also have payment processing capability and be capable of automatically creating and providing a billing agreement to the user, such as the user of device 110, based on the determined recommendation. Furthermore, based on receiving user input, recommendation application 142 may be capable of automatically processing one or more payments corresponding to the provided billing agreement. Furthermore, in the example embodiment, recommendation application 142 is capable of identifying if one or more billing agreements associated with a user correspond to one or more cancellation criteria, and based on the identifying, is capable of providing a notification to the user that includes a selectable cancellation user interface element. Recommendation application 142 is described in more detail with regard to the figures.

Furthermore, in one or more embodiments, recommendation application 142 may utilize an application programming interface (API) in communicating with other programs, and further in communicating with database 144.

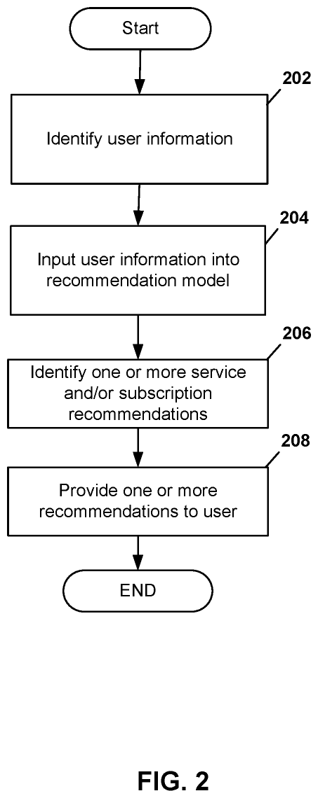

FIG. 2 is a flowchart illustrating the operations of recommendation application 142 in determining one or more service recommendations to provide a user, in accordance with an embodiment. In the example embodiment, recommendation application 142 may identify user information associated with the user of device 110 (step 202). In the example embodiment, recommendation application 142 may access database 144 in order to identify user information associated with the user of device 110. In the example embodiment, the user information may include one or more user transactions, one or more billing agreements associated with the user, one or more user attributes (such as demographic information), user financial information, and/or additional user information. In the example embodiment, a billing agreement may correspond to a particular service or subscription, and if approved by a user, may provide a payment processor the ability to automatically bill the user for the particular service or subscription.

In the example embodiment, recommendation application 142 may utilize model 146 to determine one or more service recommendations by inputting the user information into model 146 (step 204). In the example embodiment, model 146 may utilize an item based collaborative filtering algorithm to process input and provide a recommendation for users that are associated with one or more services and/or subscriptions, however, in other embodiments, other algorithms may be utilized. In the example embodiment, the item based collaborative filtering algorithm may provide recommendations based on other users who have one or more services and/or subscriptions in common with the user of device 110. For example, if User A has a billing agreement setup for service X and subscription Y, and the user of device 110 has a billing agreement setup for service X, model 146 may recommend a billing agreement associated with subscription Y. Furthermore, in the example embodiment, model 146 may access database 144 to obtain information associated with other users.

Furthermore, in the example embodiment, model 146 may utilize a user based collaborative filtering algorithm to process input and provide a recommendation for users that are not associated with one or more services and/or subscriptions, however, in other embodiments, other algorithms may be utilized. Therefore, if the user of device 110 is a new user or has not added any subscriptions and/or services into his/her account associated with recommendation application 142, model 146 may determine based on no subscription/service information being provided, that a user based collaborative filtering algorithm should be utilized to determine a recommendation to provide the user of device 110. In the example embodiment, a user based collaborative filtering algorithm may identify other users that have one or more user attributes that correspond to the user of device 110, and based on identifying the other users, may recommend one or more subscriptions and/or services to the user of device 110 (that correspond to the identified other users).

In the example embodiment, recommendation application 142, via model 146, may identify one or more service and/or subscription recommendations (step 206). In the example embodiment, model 146 may determine one or more service and/or subscription recommendations utilizing an item based collaborative filtering algorithm, however in other embodiments, one or more of the algorithms discussed above may be utilized to provide the recommendations to recommendation application 142. In the example embodiment, model 146 may also rank the recommendations based on various factors such as user preferences, similarity coefficients between users, and additional factors.

In the example embodiment, model 146 may analyze the input user information corresponding to the user of device 110, access database 144 and determine one or more associated users. Furthermore, model 146 may utilize a number of occurrences of the one or more services and/or subscriptions with regard to the determined one or more associated users to determine how to create a ranking. For example, model 146 may identify that the user of device 110 is associated with a billing agreement for subscription X, and further that 6 other users are associated with a billing agreement for subscription X (associated users). Model 146 may then determine that 3 of the 6 users also have a billing agreement for subscription Y, 2 of the 6 users have a billing agreement for subscription W, and 1 of the 6 users have a billing agreement for subscription T. Based on this determination, model 146 may rank the recommended subscriptions with subscription Y being ranked 1st, subscription W being ranked second, and subscriptions T being ranked 3rd.

In other embodiments, user preferences may also factor into the ranking of the recommended services and/or subscriptions. Referring to the example above, if subscription W is a coffee subscription service, and based on user preferences, user social media comments, and other monitored user activity that recommendation application 142 has collected and input into model 146, the user of device 110 is interested in coffee, model 146 may rank subscription W higher than subscription Y.

In further embodiments, model 146 may determine a similarity coefficient between the user of device 110 and other associated users and utilize the similarity coefficient to determine a weight value for each of the associated users. Referring to the example above, for the 6 associated users, based on user attributes, and other user information, model 146 may determine a similarity coefficient between each of the 6 associated users and the user of device 110. Based on the similarity coefficient associated with each of the 6 users, a weight value may be determined for each of the 6 users. Therefore, referring to the example above, if the weight values of the 2 users corresponding to subscription W is high, subscription W may be ranked higher than subscription Y. Furthermore, in additional embodiments, when determining a similarity coefficient, model 146 may taken user patterns into account. For example, model 146 may take user patterns with regard to subscription/service sign ups and cancellations, and determine a similarity coefficient at least partially based on the similarity between the user patterns of the user of device 110 and the associated users. In another example, if one or more associated users have canceled a language learning subscription application associated with service provider server 120 and signed up for a second language learning subscription application associated with service provider server 150, recommendation application 142 may, based on detection of this pattern, recommend a billing agreement corresponding to the language learning application associated with service provider server 150 to the user of device 110 based on detecting that the user of device 110 has canceled a language learning subscription associated with service provider server 120.

In one or more embodiments, as described above, these ranking techniques described may be used in conjunction with the user based collaborative filtering algorithm or one or more other algorithm in order to provide a recommendation.

In the example embodiment, recommendation application 142 may then provide the determined one or more recommendations to the user of device 110 (step 208). In the example embodiment, recommendation application 142 may provide at least one of the determined one or more recommendations (such as the highest ranked recommendation or recommendations) to the user of device 110. In the example embodiment, recommendation application 142 communicate with client application 112, via network 130, and utilize client application 112 to display and/or notify the recommendation or recommendations to the user of device 110.

In one or more embodiments, recommendation application 142 may provide the recommendation(s) to the user of device 110 in the form of a billing agreement. For example, based on a determination that a subscription associated with service provider server 120 ranks the highest among the determined one or more recommendations (or is to be recommended based on a high ranking), recommendation application 142 may automatically create a billing agreement corresponding to the subscription associated with service provider server 120. Recommendation application 142 may then provide the created billing agreement or a notification corresponding to the created billing agreement to the user of device 110 via client application 112. Upon detection of a selectable element within the notification (or that is associated with then notification) corresponding to an approval of the subscription, recommendation application 142 may communicate with service provider server 120 and cause the user of device 110 to be signed up for the subscription (without the user of device 110 having to take any additional action). In other embodiments, the user of device 110 may provide in a user preference that certain subscriptions or services may be signed up for without approval being required. Therefore, in these other embodiments, based on referring to the user preferences, recommendation application 142, upon determining that a subscription to be recommended fits within the subscriptions (or subscription types) that don't require approval, may automatically cause the user of device 110 to be signed up for the subscription.

In further embodiments, prior to providing the user of device 110 with a recommendation for a service or a subscription, recommendation application 142 may analyze user information associated with the user of device 110 to determine a score (such as a financial or a social score) associated with the user. In the example embodiment, the score may take things into account such as financial information/financial stability, how often the user has not made a payment for a subscription and may additionally take social metrics into account as well. Recommendation application 142 may provide the social score to the service provider associated with the service/subscription to be recommended and request approval from the service provider. Upon approval from the service provider, recommendation application 142 may proceed with providing the recommendation and signing the user up for the service/subscription if desired. In an additional embodiment, service providers may maintain a score mapping which may delineate score levels that corresponds to an automatic approval. Therefore, upon determining a score, recommendation application 142 may refer to the score mapping in order to determine if the user is automatically approved or if approval needs to be requested from the service provider.

Furthermore, in one or more embodiments, recommendation application 142 may analyze user information, such as previous transactions corresponding to signing up for services and/or subscriptions and determine an optimal time/date to provide one or more recommendations to the user of device 110. Furthermore, the optimal time/date may be determined for each specific service recommendation.

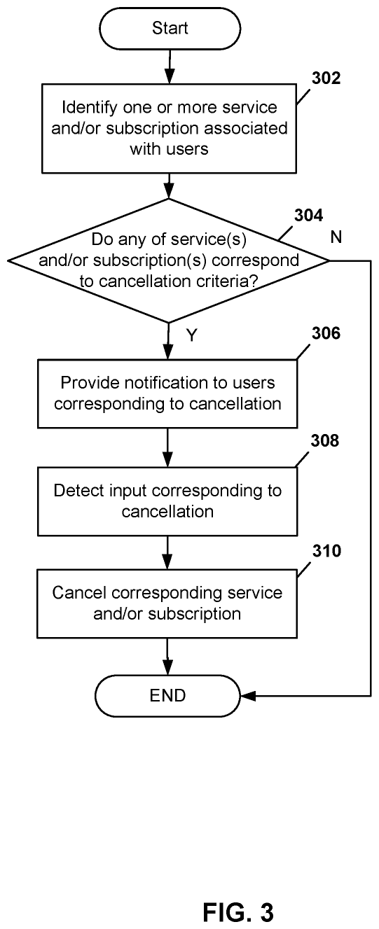

FIG. 3 is a flowchart illustrating the operations of recommendation application 142 in determining whether a billing agreement corresponds to cancellation criteria, in accordance with an embodiment.

In the example embodiment, recommendation application 142 identifies one or more services and/or subscriptions associated with the users of recommendation application 142 (step 302). In the example embodiment, recommendation application 142 may identify active services and or subscriptions that are associated with each user's account with the service provider associated with server 140. In one or more embodiments, recommendation application 142 may identify one or more billing agreements associated with each user, such as the user of device 110, in order to identify the service and/or subscriptions associated with each user.

In the example embodiment, recommendation application 142 may determine if at least one of the identified one or more services and/or subscriptions correspond to cancellation criteria (decision 304). In the example embodiment, the cancellation criteria may be general criteria maintained by recommendation application 142 with regard to all users and/or each specific user may also input criteria that recommendation application 142 may also take into account. Recommendation application 142 may then monitor activity and news corresponding to each service and/or subscription that users of recommendation application 142 are signed up for and based on the monitored activity may determine if any of the cancellation criteria has been met. For example, if the user of device 110 is signed up for subscription X and recommendation application 142 determines that the CEO of the service provider associated with subscription X has made negative statements with regard to a minority group, recommendation application 142 may analyze the statements and determine if general cancellation criteria or specific cancellation criteria corresponding to the user of device 110 have been met. In another example, if via monitored activity and news, recommendation application 142 determines that subscription X has been hacked, recommendation application 142 may analyze the level of the hack and compare the details of the hack against the cancellation criteria (general and specific) in order to determine if the cancellation criteria has been met.

In one or more embodiments, recommendation application 142 may determine a cancellation score based on the monitored activity and news. For example, each of the general and specific criteria may have weight values associated with them based on an importance set by the service provider associated with server 140 and/or the user of device 110. The weight values may be adjusted by the service provider associated with server 140 and/or the user of device 110. In these one or more embodiments, recommendation application 142 may utilize the weight values to determine a cancellation score based on monitored activity and new corresponding to specific service providers associated with services and/or subscriptions. In these one or more embodiments, multiple events or occurrences may be taken into account by recommendation application 142 in determining a cancellation score. For example, if service provider associated with subscription X is hacked and then a few months later has a company officer indicted for fraud, recommendation application 142 may determine a cancellation score based on both factors. Furthermore, if a cancellation criteria occurs multiple times (such as if a service provider is hacked twice), the weight value corresponding to the second occurrence may be higher than the first occurrence (the second hack may add more to the cancellation score than the first hack). In these one or more embodiments, recommendation application 142 may compare the determined cancellation score to a threshold cancellation score to determine the course of action to take. If the determined cancellation score exceeds the threshold score, recommendation application 142 may determine that the service and/or subscription corresponds to the cancellation criteria.

If recommendation application 142 determines that the identified one or more services and/or subscriptions do not correspond to cancellation criteria (decision 304, “NO branch”), recommendation application 142 may continue to monitor activity and news corresponding to the identified one or more services and/or subscriptions.

If recommendation application 142 determines that at least one of the identified one or more services and/or subscriptions do correspond to the cancellation criteria (decision 304, “YES” branch), recommendation application 142 may provide a notification to one or more users that correspond to the at least one of the identified one or more services and/or subscriptions that meet the cancellation criteria (step 306). In the example embodiment, the notification may include a selectable user interface element that corresponds to a cancellation of a service/subscription. Furthermore, the notification may include information corresponding to the potential cancellation such as the determined cancellation score, the monitored activity/news that corresponds to the cancellation criteria, and the cancellation criteria. In other embodiments, rather than sending a notification, if a service/subscription corresponds to one or more cancellation criteria, recommendation application 142 may automatically cancel the service/subscription.

In further embodiments, where a cancellation score is determined, recommendation application 142 may compare the determined cancellation score to multiple threshold cancellation scores. For example, if the determined cancellation score exceeds a first cancellation score (a highest score), recommendation application 142 may automatically cancel the subscription, while the recommendation application 142 may transmit the notification described above if the cancellation score is below the first threshold cancellation score but above a second threshold cancellation score.

In the example embodiment, recommendation application 142 may detect an input from the user of device 110 that corresponds to a cancellation of the at least one of the identified one or more services and/or subscriptions included in the notification (step 308), and furthermore, based on the detection, may cancel the at least one of the identified one or more services and/or subscriptions (step 310). In the example embodiment, as stated above, recommendation application 142 may create and include a selectable user interface element that corresponds to the cancellation of the service(s) and/or subscription(s) included in the notification transmitted to the user of device 110. Recommendation application 142 may then detect a selection of the selectable user interface element, and based on the detecting, may cancel the corresponding service(s) and/or subscriptions. Furthermore, in one or more embodiments, if multiple services and/or subscriptions associated with the user of device 110 are determined to correspond to cancellation criteria, recommendation application 142 may create and include multiple selectable user interface elements within the notification (or transmit multiple notifications), and based on detection of one or more selections of the user interface elements, recommendation application 142 may cancel the corresponding service(s) and/or subscription(s).

Furthermore, although in the example embodiment, recommendation application 142 provides recommendations of services and/or subscriptions to the user of device 110 via a client application (client application 112), in other embodiments, the service provider associated with server 140 may provide recommendation to the user of device 110 via a website and further may provide an interface, via a website, which the user of device 110 may utilize to manage services and subscriptions that he/she has signed up for.

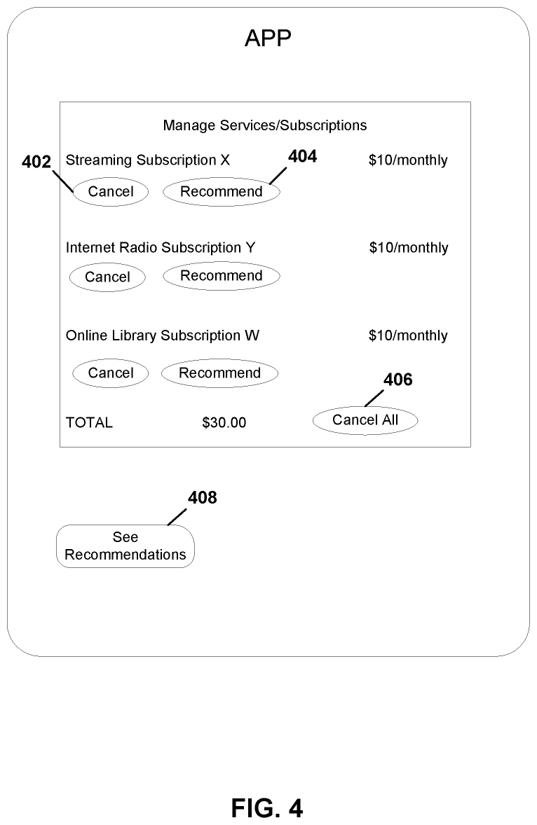

FIG. 4 is a depiction of a user interface that provides the ability for a user to manage one or more services/subscriptions, in accordance with an embodiment. In the example embodiment, FIG. 4 depicts a user interface provided to the user of device 110, via client application 112, from recommendation application 142, that displays the services and subscriptions that the user of device 110 has signed up for. In the example embodiment, recommendation application 142 provides an interface to the user of device 110 that allows the user to manage services and subscriptions that corresponds to multiple service providers. Furthermore, FIG. 4 includes element 402 which allows the user of device 110 to cancel Streaming Subscription X from within the provided user interface (without having to interface with the service provider associated with Streaming Subscription X). Furthermore, FIG. 4 also includes element 404 which allows the user of device 110 to recommend the subscription or service (such as Streaming Subscription X) to one or more other users (such as one or more other users associated with recommendation application 142). In one or more embodiments, upon selecting element 404, recommendation application 142 may provide the user of device 110 with a user interface where the user may be able to select one or more users to transmit the recommendation to (and further an option may be provided for the user to transmit a recommendation to all users, such as all users of recommendation application 142). The recommendation may be provided within a network feed of recommendation application 142.

FIG. 4 also includes element 406, which the user of device 110 may utilize to cancel all services and/or subscriptions that he/she is currently signed up for. Therefore, based on the depiction provided in FIG. 4, if the user of device 110 selects element 406, recommendation application 142 may proceed with cancelling Streaming Subscription X, Internet Radio Subscription Y, and Online Library Subscription W. In the example embodiment, FIG. 4 also includes element 408 which allows the user of device 110 to view recommendation for services and subscriptions provided by other users of recommendation application 142. In one example, the recommendations may be provided within one or more network feeds. For example, the user of device 110 may be provided with the option of viewing a network feed associated with connected users (i.e., friends, linked users) or viewing a network feed associated with all users of recommendation application 142.

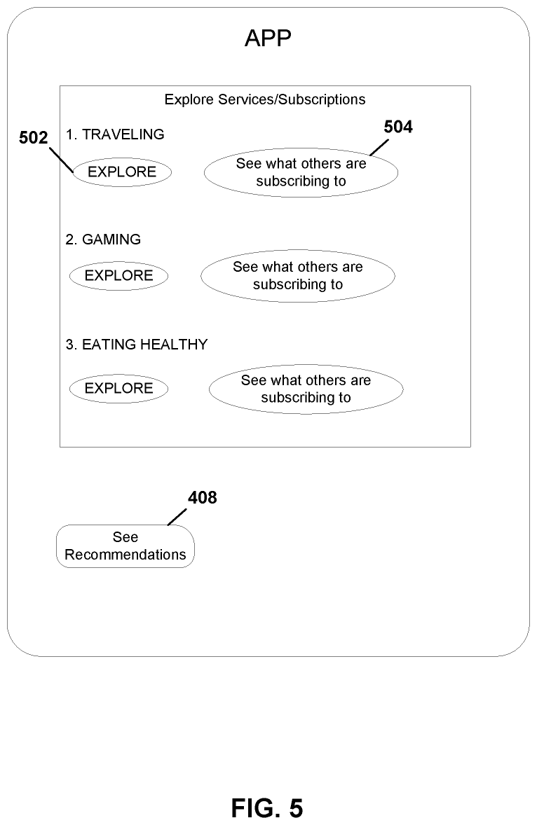

FIG. 5 is a depiction of a user interface that provides a user with a categorical view of one or more services/subscriptions, in accordance with an embodiment. In the example embodiment, FIG. 5 depicts a user interface provided by recommendation application 142 that provides the user of device 110 a way to view services and/subscriptions by way of category. In the example embodiment, element 502 is a selectable element that when selected provides a listing of services and/or subscriptions to the user of device 110 that correspond to the associated category (i.e., Traveling). In the example embodiment, element 504 is a selectable element that, when selected, provides a listing of services and/or subscriptions corresponding to what other users are subscribing to within the associated category. In the example embodiment, the listing may be provided in order of the services and/or subscriptions that users of recommendation application 142 are joining at the fastest pace (or based on the overall number of users of each service and/or subscription). In other embodiments, the listing may be provided in order of the services and/or subscriptions that connected users of the user of device 110 are joining at the fastest pace (or based on the overall number of connected users of each service and/or subscription). In further embodiments, the listing may include both services and/or subscriptions corresponding to connected user of the user of device 110 and other users of recommendation application 142. Furthermore, FIG. 5 depicts an interface that may also include element 408.

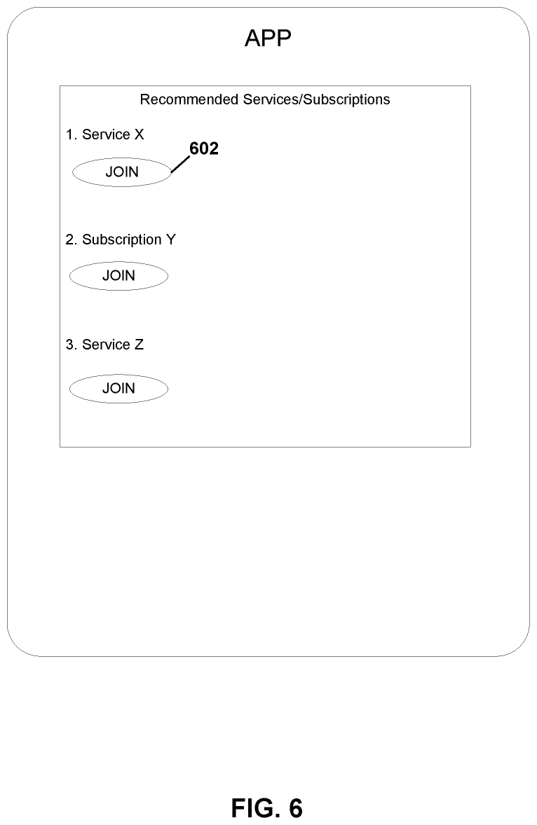

FIG. 6 is a depiction of a user interface that provides a user with one or more recommended services and/or subscriptions, in accordance with an embodiment. In the example embodiment, FIG. 6 depicts a listing of recommended services and/or subscriptions provided to the user of device 110. In the example embodiment, the depicted interface may be provided upon the user of device 110 accessing element 408. In the example embodiment, FIG. 6 includes a listing of the services and/or subscriptions, and further includes element 602, which when accessed by the user of device 110, causes recommendation application 142 to initiate the sign up of the user of device 110 with the corresponding service or subscription (i.e., Service X). Furthermore, in one or more embodiments, additional information such as connected users that have signed up for each of the recommended services/subscriptions, number of overall users that have signed up for each of the recommended services/subscriptions. Furthermore, the listing may be organized hierarchically based on recommendations provided by model 146 (as described above—i.e., associated weight values, etc.).

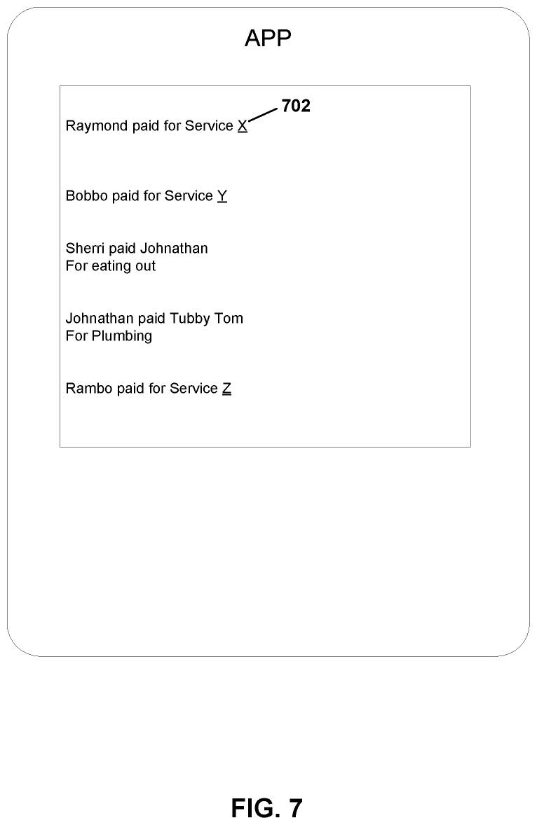

FIG. 7 is a depiction of a user interface that provides a user with a payment feed of one or more connected users, in accordance with an embodiment. In the example embodiment, FIG. 7 includes a network feed of user activity, such as user payments to other users and also for services/subscriptions. In the example embodiment, within this network feed, recommendation application 142 may provide selectable elements to the user (such as the user of device 110) that allow for the user to directly initiate sign up for a service/subscription. For example, FIG. 7 includes element 702 which when accessed, causes recommendation application 142 to initiate sign up of the user of device 110 with Service X. In the example embodiment, recommendation application 142 may provide the user of device 110 with multiple network feeds, such as one that corresponds to only connected users, and one that corresponds to all users of recommendation application 142. In other embodiments, a single network feed may be provided to the user of device 110. In one or more embodiments, upon selecting element 404, the user of device 110 may have the option of transmitting the recommendation to one or more network feeds (such as the one depicted).

In the example embodiment, the term “service” may include “subscriptions” along with other services that are not subscription based. In the example embodiment, the term “subscriptions” is intended to be a subset of “service” and correspond to services that are charged on a monthly basis that involve a consumer receiving content, an item, a service or something of value on a continuous basis or a regular basis.

The foregoing description of various embodiments of the present disclosure has been presented for purposes of illustration and description. It is not intended to be exhaustive nor to limit the disclosure to the precise form disclosed. Many modifications and variations are possible. Such modifications and variations that may be apparent to a person skilled in the art of the disclosure are intended to be included within the scope of the disclosure as defined by the accompanying claims.

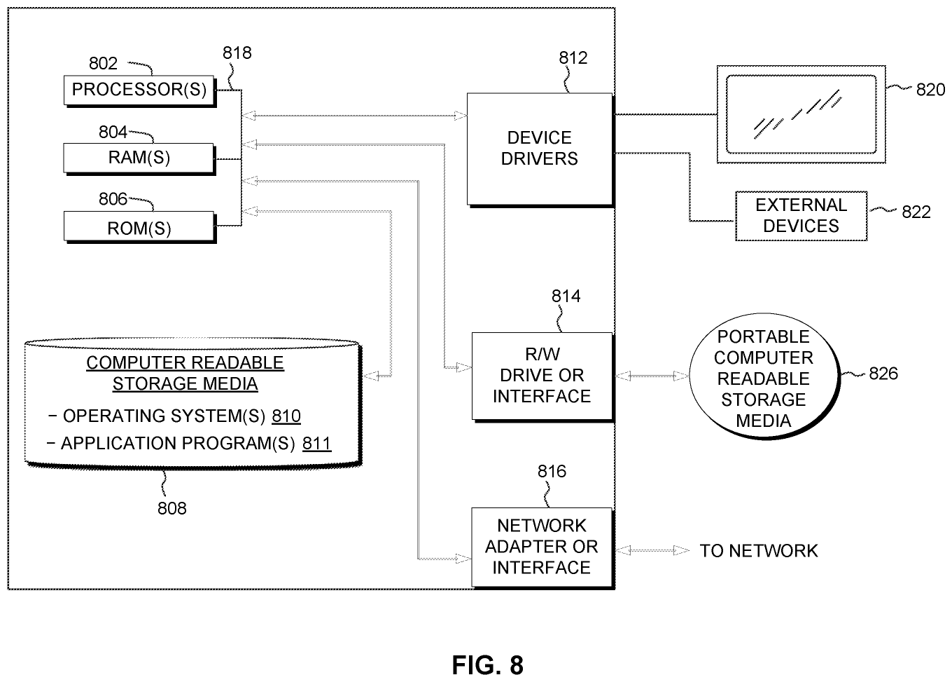

FIG. 8 depicts a block diagram of components of computing devices contained in recommendation system 100 of FIG. 1, in accordance with an embodiment. It should be appreciated that FIG. 8 provides only an illustration of one implementation and does not imply any limitations with regard to the environments in which different embodiments may be implemented. Many modifications to the depicted environment may be made.

Computing devices may include one or more processors 802, one or more computer-readable RAMs 804, one or more computer-readable ROMs 806, one or more computer readable storage media 808, device drivers 812, read/write drive or interface 814, network adapter or interface 816, all interconnected over a communications fabric 818. Communications fabric 818 may be implemented with any architecture designed for passing data and/or control information between processors (such as microprocessors, communications and network processors, etc.), system memory, peripheral devices, and any other hardware components within a system.

One or more operating systems 810, and one or more application programs 811, for example, recommendation application 142, are stored on one or more of the computer readable storage media 808 for execution by one or more of the processors 802 and by utilizing one or more of the respective RAMs 804 (which typically include cache memory). In the illustrated embodiment, each of the computer readable storage media 808 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing devices may also include a R/W drive or interface 814 to read from and write to one or more portable computer readable storage media 826. Application programs 811 on the computing devices may be stored on one or more of the portable computer readable storage media 826, read via the respective R/W drive or interface 814 and loaded into the respective computer readable storage media 808.

Computing devices may also include a network adapter or interface 816, such as a TCP/IP adapter card or wireless communication adapter (such as a 4G wireless communication adapter using OFDMA technology). Application programs 811 on the computing devices may be downloaded to the computing devices from an external computer or external storage device via a network (for example, the Internet, a local area network or other wide area network or wireless network) and network adapter or interface 816. From the network adapter or interface 816, the programs may be loaded onto computer readable storage media 808. The network may comprise copper wires, optical fibers, wireless transmission, routers, firewalls, switches, gateway computers and/or edge servers.

Computing devices may also include a display screen 820, and external devices 822, which may include, for example a keyboard, a computer mouse and/or touchpad. Device drivers 812 interface to display screen 820 for imaging, to external devices 822, and/or to display screen 820 for pressure sensing of alphanumeric character entry and user selections. The device drivers 812, R/W drive or interface 814 and network adapter or interface 816 may comprise hardware and software (stored on computer readable storage media 808 and/or ROM 806).

The programs described herein are identified based upon the application for which they are implemented in a specific embodiment. However, it should be appreciated that any particular program nomenclature herein is used merely for convenience, and thus the disclosure should not be limited to use solely in any specific application identified and/or implied by such nomenclature.

Based on the foregoing, a computer system, method, and computer program product have been disclosed. However, numerous modifications and substitutions can be made without deviating from the scope of the present disclosure. Therefore, the various embodiments have been disclosed by way of example and not limitation.

Various embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer system, comprising:
one or more computer-readable memories storing program instructions; and
one or more processors configured to execute the program instructions to cause the system to perform operations comprising:
identifying user information corresponding to a user;
analyzing the user information to identify a service associated with the user;
determining one or more other users that correspond to the identified service associated with the user;
determining one or more services to recommend to the user based on identifying a plurality of services associated with the determined one or more other users, wherein the plurality of services correspond to a plurality of service providers; and
providing one or more billing agreements to the user via a user interface, wherein the one or more billing agreements correspond to the determined one or more services.

2. The computer system of claim 1, the operations further comprising:
ranking the one or more services; and
wherein the providing the one or more billing agreements includes providing a first billing agreement that corresponds to a highest ranked service of the one or more services.

3. The computer system of claim 1, wherein the user information includes one or more user attributes, and at least one billing agreement associated with the user.

4. The computer system of claim 1, wherein the determining the one or more services that correspond to the user based on identifying a plurality of services associated with the determined one or more other users includes:
analyzing the plurality of services associated with the one or more other users;
determining a weight value corresponding to each user; and
determining a ranking of at least a portion of the plurality of services based on the weight value corresponding to each user and a number of the one or more other users that are associated with each of the plurality of services.

5. The computer system of claim 1, the operations further comprising:
in response to detecting an input that corresponds to an approval of a first billing agreement of the one or more billing agreements, causing the user to be signed up for a first service of a first service provider that corresponds to the first billing agreement.

6. The computer system of claim 1, the operations further comprising:
providing a user interface that includes one or more selectable elements corresponding to a set of billing agreements that corresponds to the user, wherein the set of billing agreements corresponds to two or more service providers, and wherein the one or more selectable elements includes a cancellation element that, when accessed, causes a corresponding service to be canceled.

7. The computer system of claim 6, wherein the one or more selectable elements includes a recommend element that, when accessed, causes a corresponding service to be recommended via a network feed to one or more other users.

8. A non-transitory computer-readable medium storing computer-executable instructions, that in response to execution by one or more hardware processors, causes the one or more hardware processors to perform operations comprising:
identifying user information corresponding to a user;
determining a plurality of services that correspond to the user based on the user information, wherein the plurality of services correspond to a plurality of service providers; and
providing one or more billing agreements to the user via a user interface, wherein the one or more billing agreements correspond to at least one of the plurality of services.

9. The non-transitory computer-readable medium of claim 8, the operations further comprising:
ranking the one or more services; and
wherein the providing the one or more billing agreements includes providing a first billing agreement that corresponds to a highest ranked service of the one or more services.

10. The non-transitory computer-readable medium of claim 8, wherein the user information includes one or more user attributes, and at least one billing agreement associated with the user.

11. The non-transitory computer-readable medium of claim 8, wherein the determining a plurality of services that correspond to the user based on the user information includes:
analyzing the user information to identify a service associated with the user;
determining one or more other users that correspond to the identified service associated with the user; and
determining that the one or more other users correspond to the plurality of services.

12. The non-transitory computer-readable medium of claim 8, the operations further comprising:
in response to detecting an input that corresponds to an approval of a first billing agreement of the one or more billing agreements, causing the user to be signed up for a first service of a first service provider that corresponds to the first billing agreement.

13. The non-transitory computer-readable medium of claim 8, the operations further comprising:
providing a user interface that includes one or more selectable elements corresponding to a set of billing agreements that corresponds to the user, wherein the set of billing agreements corresponds to two or more service providers, and wherein the one or more selectable elements includes a cancellation element that, when accessed, causes a corresponding service to be canceled.

14. The non-transitory computer-readable medium of claim 13, wherein the one or more selectable elements includes a recommend element that, when accessed, causes a corresponding service to be recommended via a network feed to one or more other users.

15. A method, comprising:
determining, by a first service provider, that a service associated with a user corresponds to one or more cancellation criteria associated with the service;
in response to the determining that the service associated with the user corresponds to one or more cancellation criteria associated with the service, providing, by the first service provider, the user with a cancellation notification, wherein the cancellation notification includes a selectable user interface element; and
in response to detecting that the selectable user interface element has been accessed, automatically initiating, by the first service provider, communication with a second service provider associated with the service to cause cancellation of the service.

16. The method of claim 15, wherein cancellation criteria includes criteria input by the user and criteria created by the first service provider.

17. The method of claim 15, further comprising:
monitoring, by the first service provider, activity corresponding to the service associated with the second service provider; and
comparing, by the first service provider, the monitored activity to one or more cancellation criteria associated with the service.

18. The method of claim 15, wherein the determining that the service associated with the user corresponds to one or more cancellation criteria associated with the service includes:
determining, by the first service provider, a cancellation score based on one or more events of a monitored activity associated with the service; and
determining, by the first service provider, that the cancellation score exceeds a cancellation threshold score.

19. The method of claim 15, wherein the cancellation notification includes a monitored activity associated with the service and the one or more cancellation criteria.

20. The method of claim 15, wherein the determining that the service associated with the user corresponds to one or more cancellation criteria associated with the service includes:
determining, by the first service provider, a cancellation score based on one or more events of a monitored activity associated with the service; and
determining, by the first service provider, that the cancellation score exceeds a first cancellation threshold score but is below a second threshold cancellation score, wherein the second threshold cancellation score corresponds to a cancellation of the service without requesting input from the user.
